(19) United States
(12) Patent Application Publication
(10) Pub. No.: US 2022/0243055 A1
(43) Pub. Date: Aug. 4, 2022

(54) Camera Module Containing A Polymer Composition

(71) Applicant: Ticona LLC, Florence, KY (US)

(72) Inventor: Young Shin Kim, Cincinnati, OH (US)

(21) Appl. No.: 17/575,995

(22) Filed: Jan. 14, 2022

Related U.S. Application Data
(60) Provisional application No. 63/145,683, filed on Feb. 4, 2021.
(60) Provisional application No. 63/159,532, filed on Mar. 11, 2021.

(51) Int. Cl. C08L 67/03; G03B 17/12; G02B 7/02

(52) U.S. Cl. CPC C08L 67/03; G03B 17/12; C08L 2203/20; C08L 2205/02; G02B 7/021

(57) ABSTRACT

A camera module comprising a polymer composition that includes a polymer matrix containing a liquid crystalline polymer and a plurality of inorganic filler particles is provided. The polymer composition exhibits an in-plane thermal conductivity of about 2.5 W/m-K or more as determined in accordance with ASTM E1461-13, and a mean coefficient of linear thermal expansion of about 50° C.⁻¹ or less as determined in a direction transverse to a flow direction in accordance with ISO 11359-2:1999 over a temperature range of from −45° C. to 200° C.

### CROSS REFERENCE TO RELATED APPLICATIONS

The present application claims filing benefit of U.S. Provisional Patent Application Ser. No. 63/145,683 having a filing date of Feb. 4, 2021 and U.S. Provisional Patent Application Ser. No. 63/159,532 having a filing date of Mar. 11, 2021, which are incorporated herein by reference in their entirety.

### BACKGROUND OF THE INVENTION

Camera modules (or components) are often employed in mobile phones, laptop computers, digital cameras, digital video cameras, etc. Examples include, for instance, compact camera modules that include a carrier mounted to a base, digital camera shutter modules, components of digital cameras, cameras in games, medical cameras, surveillance cameras, etc. Such camera modules have become more complex and now tend to include more moving parts. In some cases, for example, two compact camera module assemblies can be mounted within a single module to improve picture quality (“dual camera” modules). In other cases, an array of compact camera modules can be employed. Due to the increased complexity of different module designs, power consumption is increased, which in turn leads to an increase in the amount of heat that is produced by the module. The increased production of heat can be a problem due to the fact that certain polymeric materials (e.g., polycarbonates) have a relatively high coefficient of linear thermal expansion, which means that the material will grow substantially upon the application of heat and thus result in optical misalignment. As such, a need currently exists for a polymer composition that can be more readily employed in camera modules.

### SUMMARY OF THE INVENTION

In accordance with one embodiment of the present invention, a camera module is disclosed that comprises a polymer composition that includes a polymer matrix containing a liquid crystalline polymer and a plurality of inorganic filler particles. The polymer composition exhibits an in-plane thermal conductivity of about 2.5 W/m-K or more as determined in accordance with ASTM E1461-13, and a mean coefficient of linear thermal expansion of about 50° C.⁻¹ or less as determined in a direction transverse to a flow direction in accordance with ISO 11359-2:1999 over a temperature range of from −45° C. to 200° C.

Other features and aspects of the present invention are set forth in greater detail below.

### BRIEF DESCRIPTION OF THE FIGURES

A full and enabling disclosure of the present invention, including the best mode thereof to one skilled in the art, is set forth more particularly in the remainder of the specification, including reference to the accompanying figures, in which:

FIG. 1 is a perspective view of a camera module that may be formed in accordance with one embodiment of the present invention;

FIG. 2 is a top perspective view of one embodiment of an electronic device containing the camera module of the present invention; and

FIG. 3 is a bottom perspective view of the electronic device shown in FIG. 2.

### DETAILED DESCRIPTION

It is to be understood by one of ordinary skill in the art that the present discussion is a description of exemplary embodiments only, and is not intended as limiting the broader aspects of the present invention.

Generally speaking, the present invention is directed to a polymer composition is particularly suitable for use in a camera module. Through careful control over the specific nature and concentration of the components employed in the composition, the present inventor has discovered that the resulting composition can exhibit a unique combination of a low mean coefficient of linear thermal expansion (“CLTE”) and a high thermal conductivity, which can the degree to which it expands when subjected to heat during the production or use of a camera module. More particularly, the polymer composition may exhibit a CLTE in a direction transverse to the flow direction of about 50° C.⁻¹ or less, in some embodiments about 40° C.⁻¹ or less, in some embodiments about 35° C.⁻¹ or less, in some embodiments from about 1 to about 35° C.⁻¹, and in some embodiments, from about 2 to about 30° C.⁻¹, as determined in accordance with ISO 11359-2:1999 over a temperature range of from −45° C. to 200° C. The polymer composition may likewise exhibit a CLTE in a direction parallel to the flow direction of about 25° C.⁻¹ or less, in some embodiments about 20° C.⁻¹ or less, in some embodiments about 15° C.⁻¹ or less, and in some embodiments, from about 1 to about 13° C.⁻¹, as determined in accordance with ISO 11359-2:1999 over a temperature range of from −45° C. to 200° C.

The polymer composition may also exhibit an in-plane thermal conductivity of about 2.5 W/m-K or more, in some embodiments about 3 W/m-K or more, in some embodiments about 3.5 W/m-K or more, in some embodiments about 3.8 W/m-K or more, in some embodiments about 4 W/m-K or more, and in some embodiments, from about 4 to about 10 W/m-K, as determined in accordance with ASTM E 1461-13. Likewise, the composition may exhibit a through-plane thermal conductivity of about 0.6 W/m-K or more, in some embodiments about 0.7 W/m-K or more, in some embodiments about 0.8 W/m-K or more, and in some embodiments, from about 0.8 to about 2 W/m-K, as determined in accordance with ASTM E 1461-13. Such high thermal conductivity values allow the composition to be capable of creating a thermal pathway for heat transfer away from an electric circuit protection device within which it is employed. In this manner, “hot spots” can be quickly eliminated and the overall temperature can be lowered during use. Notably, it has been discovered that such a thermal conductivity can be achieved without use of conventional materials having a high degree of intrinsic thermal conductivity. For example, the polymer composition may be generally free of fillers having an intrinsic thermal conductivity of 50 W/m-K or more, in some embodiments 100 W/m-K or more, and in some embodiments, 150 W/m-K or more. Examples of such high intrinsic thermally conductive materials may include, for instance, boron nitride, aluminum nitride, magnesium silicon nitride, graphite (e.g., expanded graphite), silicon carbide, carbon nanotubes, zinc oxide, magnesium oxide, beryllium oxide, zirconium oxide, yttrium oxide, aluminum powder, and copper powder. While it is normally desired to minimize the presence of such high intrinsic thermally conductive materials, they may nevertheless be present in a relatively small percentage in certain embodiments, such as in an amount of about 10 wt. % or less, in some embodiments about 5 wt. % or less, and in some embodiments, from about 0.01 wt. % to about 2 wt. % of the polymer composition.

The melt viscosity of the polymer composition may also be relatively low, which can not only enhance flowability during processing, but also can synergistically improve thermal conductivity. For example, the polymer composition may have a melt viscosity of from about 1 to about 100 Pa-s, in some embodiments from about 2 to about 80 Pa-s, in some embodiments from about 5 to about 60 Pa-s, and in some embodiments, from about 10 to about 40 Pa-s, as determined at a shear rate of 1,000 seconds⁻¹. Melt viscosity may be determined in accordance with ISO Test No. 11443:2014 at a temperature that is 15° C. higher than the melting temperature of the composition (e.g., about 340° C. for a melting temperature of about 325° C.).

Despite exhibiting such a low coefficient of thermal expansion, high degree of thermal conductivity, and low melt viscosity, the polymer composition may nevertheless still exhibit excellent mechanical properties. For example, the composition may exhibit a Charpy unnotched impact strength of about 10 kJ/m², in some embodiments from about 15 to about 60 kJ/m², and in some embodiments, from about 20 to about 50 kJ/m², measured at 23° C. according to ISO Test No. 179-1:2010. The composition may also exhibit a tensile strength of from about 20 to about 500 MPa, in some embodiments from about 50 to about 400 MPa, and in some embodiments, from about 60 to about 350 MPa; tensile break strain of about 0.5% or more, in some embodiments from about 0.8% to about 15%, and in some embodiments, from about 1% to about 10%; and/or tensile modulus of from about 5,000 MPa to about 30,000 MPa, in some embodiments from about 7,000 MPa to about 25,000 MPa, and in some embodiments, from about 9,000 MPa to about 20,000 MPa. The tensile properties may be determined in accordance with ISO Test No. 527:2019 at 23° C. The composition may also exhibit a flexural strength of from about 40 to about 500 MPa, in some embodiments from about 50 to about 400 MPa, and in some embodiments, from about 100 to about 350 MPa; flexural break strain of about 0.5% or more, in some embodiments from about 0.8% to about 15%, and in some embodiments, from about 1% to about 10%; and/or flexural modulus of about 7,000 MPa or more, in some embodiments from about 8,000 MPa or more, in some embodiments, from about 9,000 MPa to about 30,000 MPa, and in some embodiments, from about 10,000 MPa to about 25,000 MPa. The flexural properties may be determined in accordance with ISO Test No. 178:2019 at 23° C. The composition may also exhibit a deflection temperature under load (DTUL) of about 180° C. or more, in some embodiments from about 200° C. to about 320° C., and in some embodiments, from about 250° C. to about 300° C., as determined according to ISO Test No. 75-2:2013 at a specified load of 1.8 MPa.

Various embodiments of the present invention will now be described in more detail.

### I. Polymer Composition

A. Polymer Matrix

The polymer matrix typically contains one or more liquid crystalline polymers, generally in an amount of from about 20 wt. % to about 65 wt. %, in some embodiments from about 25 wt. % to about 60 wt. %, and in some embodiments, from about 30 wt. % to about 55 wt. % of the polymer composition. The liquid crystalline polymers are generally classified as “thermotropic” to the extent that they can possess a rod-like structure and exhibit a crystalline behavior in their molten state (e.g., thermotropic nematic state). The polymers have a relatively high melting temperature, such as from about 280° C. to about 400° C., in some embodiments from about 290° C. to about 390° C., and in some embodiments, from about 300° C. to about 380° C. Such polymers may be formed from one or more types of repeating units as is known in the art. A liquid crystalline polymer may, for example, contain one or more aromatic ester repeating units generally represented by the following Formula (I):

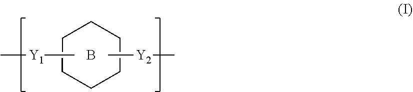

wherein,

ring B is a substituted or unsubstituted 6-membered aryl group (e.g., 1,4-phenylene or 1,3-phenylene), a substituted or unsubstituted 6-membered aryl group fused to a substituted or unsubstituted 5- or 6-membered aryl group (e.g., 2,6-naphthalene), or a substituted or unsubstituted 6-membered aryl group linked to a substituted or unsubstituted 5- or 6-membered aryl group (e.g., 4,4-biphenylene); and

Y₁ and Y₂ are independently O, C(O), NH, C(O)HN, or NHC(O).

Typically, at least one of Y₁ and Y₂ are C(O). Examples of such aromatic ester repeating units may include, for instance, aromatic dicarboxylic repeating units (Y₁ and Y₂ in Formula I are C(O)), aromatic hydroxycarboxylic repeating units (Y₁ is O and Y₂ is C(O) in Formula I), as well as various combinations thereof.

Aromatic hydroxycarboxylic repeating units, for instance, may be employed that are derived from aromatic hydroxycarboxylic acids, such as, 4-hydroxybenzoic acid; 4-hydroxy-4′-biphenylcarboxylic acid; 2-hydroxy-6-naphthoic acid; 2-hydroxy-5-naphthoic acid; 3-hydroxy-2-naphthoic acid; 2-hydroxy-3-naphthoic acid; 4′-hydroxyphenyl-4-benzoic acid; 3′-hydroxyphenyl-4-benzoic acid; 4′-hydroxyphenyl-3-benzoic acid, etc., as well as alkyl, alkoxy, aryl and halogen substituents thereof, and combination thereof. Particularly suitable aromatic hydroxycarboxylic acids are 4-hydroxybenzoic acid (“HBA”) and 6-hydroxy-2-naphthoic acid (“HNA”). When employed, repeating units derived from hydroxycarboxylic acids (e.g., HBA and/or HNA) typically constitute about 20 mol. % or more, in some embodiments about 25 mol. % or more, in some embodiments about 30 mol. % or more, in some embodiments about 40 mol. % or more, in some embodiments about 50 mol. % or more, in some embodiments from about 55 mol. % to 100 mol. %, and in some embodiments, from about 60 mol. % to about 95 mol. % of the polymer.

Aromatic dicarboxylic repeating units may also be employed that are derived from aromatic dicarboxylic acids, such as terephthalic acid, isophthalic acid, 2,6-naphthalenedicarboxylic acid, diphenyl ether-4,4′-dicarboxylic acid, 1,6-naphthalenedicarboxylic acid, 2,7-naphthalenedicarboxylic acid, 4,4′-dicarboxybiphenyl, bis(4-carboxyphenyl)ether, bis(4-carboxyphenyl)butane, bis(4-carboxyphenyl)ethane, bis(3-carboxyphenyl)ether, bis(3-carboxyphenyl)ethane, etc., as well as alkyl, alkoxy, aryl and halogen substituents thereof, and combinations thereof. Particularly suitable aromatic dicarboxylic acids may include, for instance, terephthalic acid (“TA”), isophthalic acid (“IA”), and 2,6-naphthalenedicarboxylic acid (“NDA”). When employed, repeating units derived from aromatic dicarboxylic acids (e.g., IA, TA, and/or NDA) each typically constitute from about 1 mol. % to about 40 mol. %, in some embodiments from about 2 mol. % to about 30 mol. %, and in some embodiments, from about 5 mol. % to about 25 mol. % of the polymer.

Other repeating units may also be employed in the polymer. In certain embodiments, for instance, repeating units may be employed that are derived from aromatic diols, such as hydroquinone, resorcinol, 2,6-dihydroxynaphthalene, 2,7-dihydroxynaphthalene, 1,6-dihydroxynaphthalene, 4,4′-dihydroxybiphenyl (or 4,4′-biphenol), 3,3′-dihydroxybiphenyl, 3,4′-dihydroxybiphenyl, 4,4′-dihydroxybiphenyl ether, bis(4-hydroxyphenyl)ethane, etc., as well as alkyl, alkoxy, aryl and halogen substituents thereof, and combinations thereof. Particularly suitable aromatic diols may include, for instance, hydroquinone (“HQ”) and 4,4′-biphenol (“BP”). When employed, repeating units derived from aromatic diols (e.g., HQ and/or BP) typically constitute from about 1 mol. % to about 50 mol. %, in some embodiments from about 1 mol. % to about 40 mol. %, in some embodiments from about 2 mol. % to about 40 mol. %, in some embodiments from about 5 mol. % to about 35 mol. %, and in some embodiments, from about 5 mol. % to about 25 mol. % of the polymer.

Repeating units may also be employed, such as those derived from aromatic amides (e.g., acetaminophen (“APAP”)) and/or aromatic amines (e.g., 4-aminophenol (“AP”), 3-aminophenol, 1,4-phenylenediamine, 1,3-phenylenediamine, etc.). When employed, repeating units derived from aromatic amides (e.g., APAP) and/or aromatic amines (e.g., AP) typically constitute from about 0.1 mol. % to about 20 mol. %, in some embodiments from about 0.5 mol. % to about 15 mol. %, and in some embodiments, from about 1 mol. % to about 10 mol. % of the polymer. It should also be understood that various other monomeric repeating units may be incorporated into the polymer. For instance, in certain embodiments, the polymer may contain one or more repeating units derived from non-aromatic monomers, such as aliphatic or cycloaliphatic hydroxycarboxylic acids, dicarboxylic acids, diols, amides, amines, etc. Of course, in other embodiments, the polymer may be “wholly aromatic” in that it lacks repeating units derived from non-aromatic (e.g., aliphatic or cycloaliphatic) monomers.

In certain embodiments, the liquid crystalline polymer may be a “high naphthenic” polymer to the extent that it contains a relatively high content of repeating units derived from naphthenic hydroxycarboxylic acids and naphthenic dicarboxylic acids, such as NDA, HNA, or combinations thereof. That is, the total amount of repeating units derived from naphthenic hydroxycarboxylic and/or dicarboxylic acids (e.g., NDA, HNA, or a combination of HNA and NDA) is typically about 10 mol. % or more, in some embodiments about 12 mol. % or more, in some embodiments about 15 mol. % or more, in some embodiments about 18 mol. % or more, in some embodiments about 30 mol. % or more, in some embodiments about 40 mol. % or more, in some embodiments about 45 mol. % or more, in some embodiments about 50 mol. % or more, in some embodiments about 60 mol. % or more, in some embodiments about 62 mol. % or more, in some embodiments about 68 mol. % or more, in some embodiments about 70 mol. % or more, and in some embodiments, from about 70 mol. % to about 80 mol. % of the polymer.

In one embodiment, for instance, the repeating units derived from HNA may constitute 30 mol. % or more, in some embodiments about 40 mol. % or more, in some embodiments about 45 mol. % or more, in some embodiments 50 mol. % or more, in some embodiments about 60 mol. % or more, in some embodiments about 62 mol. % or more, in some embodiments about 68 mol. % or more, in some embodiments about 70 mol. % or more, and in some embodiments, from about 70 mol. % to about 80 mol. % of the polymer. The liquid crystalline polymer may also contain various other monomers. For example, the polymer may contain repeating units derived from HBA in an amount of from about 10 mol. % to about 40 mol. %, and in some embodiments from about 15 mol. % to about 35 mol. %, and in some embodiments, from about 20 mol. % to about 30 mol. %. When employed, the molar ratio of HNA to HBA may be selectively controlled within a specific range to help achieve the desired properties, such as from about 0.1 to about 40, in some embodiments from about 0.5 to about 20, in some embodiments from about 0.8 to about 10, and in some embodiments, from about 1 to about 5. The polymer may also contain aromatic dicarboxylic acid(s) (e.g., IA and/or TA) in an amount of from about 1 mol. % to about 40 mol. %, and in some embodiments, from about 5 mol. % to about 25 mol. %; and/or aromatic diol(s) (e.g., BP and/or HQ) in an amount of from about 1 mol. % to about 40 mol. %, and in some embodiments, from about 5 mol. % to about 25 mol. %. In some cases, however, it may be desired to minimize the presence of such monomers in the polymer to help achieve the desired properties. For example, the total amount of aromatic dicarboxylic acid(s) (e.g., IA and/or TA) may be about 20 mol % or less, in some embodiments about 15 mol. % or less, in some embodiments about 10 mol. % or less, in some embodiments, from 0 mol. % to about 5 mol. %, and in some embodiments, from 0 mol. % to about 2 mol. % of the polymer. Similarly, the total amount of aromatic dicarboxylic acid(s) (e.g., IA and/or TA) may be about 20 mol % or less, in some embodiments about 15 mol. % or less, in some embodiments about 10 mol. % or less, in some embodiments, from 0 mol. % to about 5 mol. %, and in some embodiments, from 0 mol. % to about 2 mol. % of the polymer (e.g., 0 mol. %).

In another embodiment, the repeating units derived from NDA may constitute 10 mol. % or more, in some embodiments about 12 mol. % or more, in some embodiments about 15 mol. % or more, and in some embodiments, from about 18 mol. % to about 95 mol. % of the polymer. In such embodiments, the liquid crystalline polymer may also contain various other monomers, such as aromatic hydroxycarboxylic acid(s) (e.g., HBA) in an amount of from about 20 mol. % to about 60 mol. %, and in some embodiments, from about 30 mol. % to about 50 mol. %; aromatic dicarboxylic acid(s) (e.g., IA and/or TA) in an amount of from about 2 mol. % to about 30 mol. %, and in some embodiments, from about 5 mol. % to about 25 mol. %; and/or aromatic diol(s) (e.g., BP and/or HQ) in an amount of from about 2 mol. % to about 40 mol. %, and in some embodiments, from about 5 mol. % to about 35 mol. %.

Although not required in all instances, it is often desired that a substantial portion of the polymer matrix is formed from high naphthenic polymers such as described above. For example, such high naphthenic polymers as described herein typically constitute 50 wt. % or more, in some embodiments about 65 wt. % or more, in some embodiments from about 70 wt. % to 100 wt. %, and in some embodiments, from about 80 wt. % to 100% of the polymer matrix (e.g., 100 wt. %).

B. Inorganic Filler Particles

The polymer composition also generally contains inorganic filler particles that may be distributed within the polymer matrix. Such particles typically constitute from about 60 to about 300 parts by weight, in some embodiments from about 80 to about 250 parts by weight, in some embodiments from about 90 to about 225 parts by weight, and in some embodiments, from about 100 to about 200 parts by weight per 100 parts by weight of the polymer matrix. The inorganic filler particles may, for instance, constitute from about 30 wt. % to about 70 wt. %, in some embodiments from about 35 wt. % to about 65 wt. %, and in some embodiments, from about 40 wt. % to about 60 wt. % of the polymer composition. In certain embodiments, the particles may be formed from a natural and/or synthetic mineral, such as talc, mica, halloysite, kaolinite, illite, montmorillonite, vermiculite, palygorskite, pyrophyllite, calcium silicate, aluminum silicate, wollastonite, etc. Talc is particularly suitable for use in the polymer composition. Other suitable inorganic filler particles may include, for instance, silica, alumina, calcium carbonate, etc. The shape of the particles may vary as desired, such as granular, flake-shaped, etc. The particles typically have a median particle diameter (D50) of from about 1 to about 25 micrometers, in some embodiments from about 2 to about 15 micrometers, and in some embodiments, from about 4 to about 10 micrometers, as determined by sedimentation analysis (e.g., Sedigraph 5120). If desired, the particles may also have a high specific surface area, such as from about 1 square meters per gram (m²/g) to about 50 m²/g, in some embodiments from about 1.5 m²/g to about 25 m²/g, and in some embodiments, from about 2 m²/g to about 15 m²/g. Surface area may be determined by the physical gas adsorption (BET) method (nitrogen as the adsorption gas) in accordance with DIN 66131:1993. The moisture content may also be relatively low, such as about 5% or less, in some embodiments about 3% or less, and in some embodiments, from about 0.1 to about 1% as determined in accordance with ISO 787-2:1981 at a temperature of 105° C.

C. Optional Components
i. Metal Hydroxide

In one embodiment, a metal hydroxide may also be distributed within the polymer matrix. The metal hydroxide may constitute from about 0.1 to about 20 parts by weight, in some embodiments from about 0.3 to about 10 parts by weight, in some embodiments from about 0.5 to about 5 parts by weight, and in some embodiments, from about 0.8 to about 3 parts by weight per 100 parts by weight of the polymer matrix. The metal hydroxide may, for instance, constitute from about 0.01 wt. % to about 5 wt. %, in some embodiments from about 0.05 wt. % to about 2 wt. %, and in some embodiments, from about 0.1 wt. % to about 1 wt. % of the polymer composition. The metal hydroxide typically has the general formula M(OH)ₐO_{b}, where 0≤a≤3 (e.g., 3) and b=(3−a)/2, where M is a metal, such as a transition metal (e.g., copper), alkali metal (e.g., potassium sodium, etc.), alkaline earth metal (e.g., calcium, magnesium, etc.), post-transition group metal (e.g., aluminum), and so forth. Particularly suitable metals include aluminum and magnesium. Without intending to be limited by theory, it is believed that such compounds can effectively “lose” water under the process conditions (e.g., high temperature), which can assist in melt viscosity reduction and improve the flow properties of the polymer composition. Examples of suitable metal hydroxides may include, for instance, copper (II) hydroxide (Cu(OH)₂), potassium hydroxide (KOH), sodium hydroxide (NaOH), magnesium hydroxide (Mg(OH)₂), calcium hydroxide (Ca(OH)₂), aluminum hydroxide (Al(OH)₃), and so forth. The metal hydroxide is typically in the form of particles. In one particular embodiment, for example, the metal hydroxide particles include aluminum hydroxide and optionally exhibit a gibbsite crystal phase. The particles may have a relatively small size, such as a median diameter of from about 50 nanometers to about 3,000 nanometers, in some embodiments from about 100 nanometers to about 2,000 nanometers, and in some embodiments, from about 500 nanometers to about 1,500 nanometers. The term “median” diameter as used herein refers to the “D50” size distribution of the particles, which is the point at which 50% of the particles have a smaller size. The particles may likewise have a D90 size distribution within the ranges noted above. The diameter of particles may be determined using known techniques, such as by ultracentrifuge, laser diffraction, etc. For example, particle size distribution can be determined with laser diffraction according to ISO 13320:2020.
ii. Glass Fibers

One beneficial aspect of the present invention is that good mechanical properties may be achieved without adversely impacting the dimensional stability of the resulting part. To help ensure that this dimensional stability is maintained, it is generally desirable that the polymer composition remains substantially free of conventional fibrous fillers, such as glass fibers. Thus, if employed at all, glass fibers typically constitute no more than about 10 wt. %, in some embodiments no more than about 5 wt. %, and in some embodiments, from about 0.001 wt. % to about 3 wt. % of the polymer composition.
iii. Impact Modifier

If desired, an impact modifier may be employed in the polymer composition to help improve the impact strength and flexibility of the polymer composition. When employed, impact modifiers typically constitute from about 0.1 to about 20 parts, in some embodiments from about 0.5 to about 15 parts, and in some embodiments, from about 1 to about 10 parts by weight per 100 parts by weight of the polymer matrix. For instance, impact modifiers may constitute from about 0.1 wt. % to about 15 wt. %, in some embodiments from about 0.2 wt. % to about 12 wt. %, and in some embodiments, from about 0.5 wt. % to about 10 wt. % of the polymer composition.

In certain embodiments, for instance, the impact modifier may be a polymer that contains an olefinic monomeric unit that derived from one or more α-olefins. Examples of such monomers include, for instance, linear and/or branched α-olefins having from 2 to 20 carbon atoms and typically from 2 to 8 carbon atoms. Specific examples include ethylene, propylene, 1-butene; 3-methyl-1-butene, 3,3-dimethyl-1-butene, 1-pentene; 1-pentene with one or more methyl, ethyl or propyl substituents; 1-hexene with one or more methyl, ethyl or propyl substituents; 1-heptene with one or more methyl, ethyl or propyl substituents; 1-octene with one or more methyl, ethyl or propyl substituents; 1-nonene with one or more methyl, ethyl or propyl substituents; ethyl, methyl or dimethyl-substituted 1-decene; 1-dodecene; and styrene. Particularly desired α-olefin monomers are ethylene and propylene. The olefin polymer may be in the form of a copolymer that contains other monomeric units as known in the art. For example, another suitable monomer may include a “(meth)acrylic” monomer, which includes acrylic and methacrylic monomers, as well as salts or esters thereof, such as acrylate and methacrylate monomers. Examples of such (meth)acrylic monomers may include methyl acrylate, ethyl acrylate, n-propyl acrylate, i-propyl acrylate, n-butyl acrylate, s-butyl acrylate, i-butyl acrylate, t-butyl acrylate, n-amyl acrylate, i-amyl acrylate, isobornyl acrylate, n-hexyl acrylate, 2-ethylbutyl acrylate, 2-ethylhexyl acrylate, n-octyl acrylate, n-decyl acrylate, methylcyclohexyl acrylate, cyclopentyl acrylate, cyclohexyl acrylate, methyl methacrylate, ethyl methacrylate, 2-hydroxyethyl methacrylate, n-propyl methacrylate, n-butyl methacrylate, i-propyl methacrylate, i-butyl methacrylate, n-amyl methacrylate, n-hexyl methacrylate, i-amyl methacrylate, s-butyl-methacrylate, t-butyl methacrylate, 2-ethylbutyl methacrylate, methylcyclohexyl methacrylate, cinnamyl methacrylate, crotyl methacrylate, cyclohexyl methacrylate, cyclopentyl methacrylate, 2-ethoxyethyl methacrylate, isobornyl methacrylate, etc., as well as combinations thereof. In one embodiment, for instance, the impact modifier may be an ethylene methacrylic add copolymer (“EMAC”). When employed, the relative portion of the monomeric component(s) may be selectively controlled. The α-olefin monomer(s) may, for instance, constitute from about 55 wt. % to about 95 wt. %, in some embodiments from about 60 wt. % to about 90 wt. %, and in some embodiments, from about 65 wt. % to about 85 wt. % of the copolymer. Other monomeric components (e.g., (meth)acrylic monomers) may constitute from about 5 wt. % to about 35 wt. %, in some embodiments from about 10 wt. % to about 32 wt. %, and in some embodiments, from about 15 wt. % to about 30 wt. % of the copolymer.

Other suitable olefin copolymers may be those that are “epoxy-functionalized” in that they contain, on average, two or more epoxy functional groups per molecule. The copolymer may also contain an epoxy-functional monomeric unit. One example of such a unit is an epoxy-functional (meth)acrylic monomeric component. For example, suitable epoxy-functional (meth)acrylic monomers may include, but are not limited to, those containing 1,2-epoxy groups, such as glycidyl acrylate and glycidyl methacrylate. Other suitable epoxy-functional monomers include allyl glycidyl ether, glycidyl ethylacrylate, and glycidyl itoconate. Other suitable monomers may also be employed to help achieve the desired molecular weight. In one particular embodiment, for example, the copolymer may be a terpolymer formed from an epoxy-functional (meth)acrylic monomeric component, α-olefin monomeric component, and non-epoxy functional (meth)acrylic monomeric component. The copolymer may, for instance, be poly(ethylene-co-butylacrylate-co-glycidyl methacrylate). When employed, the epoxy-functional (meth)acrylic monomer(s) typically constitutes from about 1 wt. % to about 20 wt. %, in some embodiments from about 2 wt. % to about 15 wt. %, and in some embodiments, from about 3 wt. % to about 10 wt. % of the copolymer.
iv. Epoxy Resin

Epoxy resins may also be employed in certain embodiments, such as to help minimize the degree to which blends of aromatic polymers (e.g., liquid crystalline polymer and semi-crystalline aromatic polyester) react together during formation of the polymer composition. When employed, epoxy resins typically constitute from about 0.01 to about 5 parts, in some embodiments from about 0.05 to about 4 parts, and in some embodiments, from about 0.1 to about 2 parts by weight per 100 parts of the polymer matrix. For instance, epoxy resins may constitute from about 0.01 wt. % to about 5 wt. %, in some embodiments from about 0.1 wt. % to about 4 wt. %, and in some embodiments, from about 0.3 wt. % to about 2 wt. % of the polymer composition.

Epoxy resins have a certain epoxy equivalent weight may be particularly effective for use in the polymer composition. Namely, the epoxy equivalent weight is generally from about 250 to about 1,500, in some embodiments from about 400 to about 1,000, and in some embodiments, from about 500 to about 800 grams per gram equivalent as determined in accordance with ASTM D1652-11e1. The epoxy resin also typically contains, on the average, at least about 1.3, in some embodiments from about 1.6 to about 8, and in some embodiments, from about 3 to about 5 epoxide groups per molecule. The epoxy resin also typically has a relatively low dynamic viscosity, such as from about 1 centipoise to about 25 centipoise, in some embodiments 2 centipoise to about 20 centipoise, and in some embodiments, from about 5 centipoise to about 15 centipoise, as determined in accordance with ASTM D445-15 at a temperature of 25° C. At room temperature (25° C.), the epoxy resin is also typically a solid or semi-solid material having a melting point of from about 50° C. to about 120° C., in some embodiments from about 60° C. to about 110° C., and in some embodiments, from about 70° C. to about 100° C.

The epoxy resin can be saturated or unsaturated, linear or branched, aliphatic, cycloaliphatic, aromatic or heterocyclic, and may bear substituents which do not materially interfere with the reaction with the oxirane. Suitable epoxy resins include, for instance, glycidyl ethers (e.g., diglycidyl ether) that are prepared by reacting an epichlorohydrin with a hydroxyl compound containing at least 1.5 aromatic hydroxyl groups, optionally under alkaline reaction conditions. Multi-functional compounds are particularly suitable. For instance, the epoxy resin may be a diglycidyl ether of a dihydric phenol, diglycidyl ether of a hydrogenated dihydric phenol, triglycidyl ether of a trihydric phenol, triglycidyl ether of a hydrogenated trihydric phenol, etc. Diglycidyl ethers of dihydric phenols may be formed, for example, by reacting an epihalohydrin with a dihydric phenol. Examples of suitable dihydric phenols include, for instance, 2,2-bis(4-hydroxyphenyl) propane (“bisphenol A”); 2,2-bis 4-hydroxy-3-tert-butylphenyl) propane; 1,1-bis(4-hydroxyphenyl) ethane; 1,1-bis(4-hydroxyphenyl) isobutane; bis(2-hydroxy-1-naphthyl) methane; 1,5 dihydroxynaphthalene; 1,1-bis(4-hydroxy-3-alkylphenyl) ethane, etc. Suitable dihydric phenols can also be obtained from the reaction of phenol with aldehydes, such as formaldehyde) (“bisphenol F”). Commercially available examples of such multi-functional epoxy resins may include Epon™ resins available from Hexion under the designations 862, 828, 826, 825, 1001, 1002, 1009, SU3, 154, 1031, 1050, 133, and 165. Other suitable multi-functional epoxy resins are available from Huntsman under the trade designation Araldite™ (e.g., Araldite™ ECN 1273 and Araldite™ ECN 1299.
v. Antistatic Filler

An antistatic filler may also be employed in the polymer composition to help reduce the tendency to create a static electric charge during a molding operation, transportation, collection, assembly, etc. Such fillers, when employed, typically constitute from about 0.1 to about 20 parts, in some embodiments from about 0.2 to about 10 parts, and in some embodiments, from about 0.5 to about 5 parts by weight per 100 parts by weight of the polymer matrix. For instance, the antistatic filler may constitute from about 0.1 wt. % to about 10 wt. %, in some embodiments from about 0.2 wt. % to about 8 wt. %, and in some embodiments, from about 0.5 wt. % to about 4 wt. % of the polymer composition.

Any of a variety of antistatic fillers may generally be employed in the polymer composition to help improve its antistatic characteristics. Examples of suitable antistatic fillers may include, for instance, metal particles (e.g., aluminum flakes), metal fibers, carbon particles (e.g., graphite, expanded graphite, grapheme, carbon black, graphitized carbon black, etc.), carbon nanotubes, carbon fibers, and so forth. In one embodiment, for instance, the antistatic filler may be an ionic liquid. One benefit of such a material is that, in addition to being an antistatic agent, the ionic liquid can also exist in liquid form during melt processing, which allows it to be more uniformly blended within the polymer matrix. This improves electrical connectivity and thereby enhances the ability of the composition to rapidly dissipate static electric charges from its surface. The ionic liquid is generally a salt that has a low enough melting temperature so that it can be in the form of a liquid when melt processed with the liquid crystalline polymer. For example, the melting temperature of the ionic liquid may be about 400° C. or less, in some embodiments about 350° C. or less, in some embodiments from about 1° C. to about 100° C., and in some embodiments, from about 5° C. to about 50° C. The salt contains a cationic species and counterion. The cationic species contains a compound having at least one heteroatom (e.g., nitrogen or phosphorous) as a “cationic center.” Examples of such heteroatomic compounds include, for instance, quaternary oniums having the following structures:

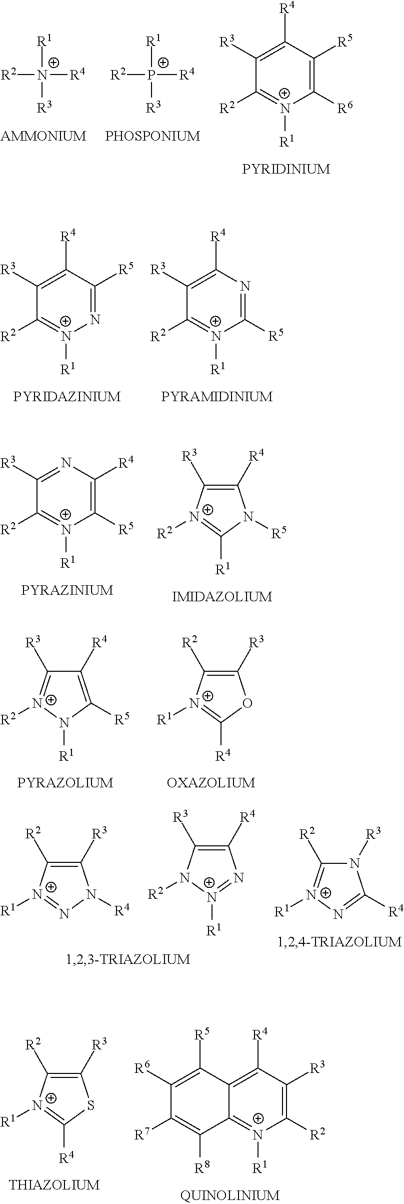

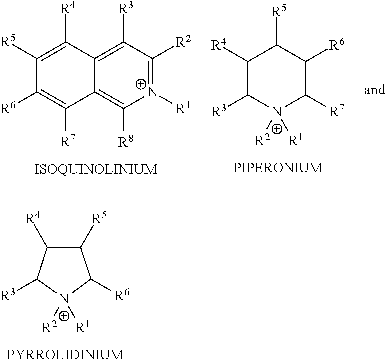

wherein, R¹, R², R³, R⁴, R⁵, R⁶, R⁷, and R⁸ are independently selected from the group consisting of hydrogen; substituted or unsubstituted C₁-C₁₀ alkyl groups (e.g., methyl, ethyl, n-propyl, isopropyl, n-butyl, isobutyl, sec-butyl, tert-butyl, n-pentyl, etc.); substituted or unsubstituted C₃-C₁₄ cycloalkyl groups (e.g., adamantyl, cyclopropyl, cyclobutyl, cyclopentyl, cyclooctyl, cyclohexenyl, etc.); substituted or unsubstituted alkenyl groups (e.g., ethylene, propylene, 2-methypropylene, pentylene, etc.); substituted or unsubstituted C₂-C₁₀ alkynyl groups (e.g., ethynyl, propynyl, etc.); substituted or unsubstituted C₁-C₁₀ alkoxy groups (e.g., methoxy, ethoxy, n-propoxy, isopropoxy, n-butoxy, t-butoxy, sec-butoxy, n-pentoxy, etc.); substituted or unsubstituted acyloxy groups (e.g., methacryloxy, methacryloxyethyl, etc.); substituted or unsubstituted aryl groups (e.g., phenyl); substituted or unsubstituted heteroaryl groups (e.g., pyridyl, furanyl, thienyl, thiazolyl, isothiazolyl, triazolyl, imidazolyl, isoxazolyl, pyrrolyl, pyrazolyl, pyridazinyl, pyrimidinyl, quinolyl, etc.); and so forth. In one particular embodiment, for example, the cationic species may be an ammonium compound having the structure N⁺R¹R²R³R⁴, wherein R¹, R², and/or R³ are independently a C₁-C₆ alkyl (e.g., methyl, ethyl, butyl, etc.) and R⁴ is hydrogen or a C₁-C₄ alkyl group (e.g., methyl or ethyl). For example, the cationic component may be tri-butylmethylammonium, wherein R¹, R², and R³ are butyl and R⁴ is methyl.

Suitable counterions for the cationic species may include, for example, halogens (e.g., chloride, bromide, iodide, etc.); sulfates or sulfonates (e.g., methyl sulfate, ethyl sulfate, butyl sulfate, hexyl sulfate, octyl sulfate, hydrogen sulfate, methane sulfonate, dodecylbenzene sulfonate, dodecylsulfate, trifluoromethane sulfonate, heptadecafluorooctanesulfonate, sodium dodecylethoxysulfate, etc.); sulfosuccinates; amides (e.g., dicyanamide); imides (e.g., bis(pentafluoroethyl-sulfonyl)imide, bis(trifluoromethylsulfonyl)imide, bis(trifluoromethyl)imide, etc.); borates (e.g., tetrafluoroborate, tetracyanoborate, bis[oxalato]borate, bis[salicylato]borate, etc.); phosphates or phosphinates (e.g., hexafluorophosphate, diethylphosphate, bis(pentafluoroethyl)phosphinate, tris(pentafluoroethyl)-trifluorophosphate, tris(nonafluorobutyl)trifluorophosphate, etc.); antimonates (e.g., hexafluoroantimonate); aluminates (e.g., tetrachloroaluminate); fatty acid carboxylates (e.g., oleate, isostearate, pentadecafluorooctanoate, etc.); cyanates; acetates; and so forth, as well as combinations of any of the foregoing. To help improve compatibility with the liquid crystalline polymer, it may be desired to select a counterion that is generally hydrophobic in nature, such as imides, fatty acid carboxylates, etc. Particularly suitable hydrophobic counterions may include, for instance, bis(pentafluoroethylsulfonyl)imide, bis(trifluoromethylsulfonyl)imide, and bis(trifluoromethyl)imide.
vi. Other Additives

A wide variety of additional additives can also be included in the polymer composition, such as lubricants, thermally conductive fillers, pigments (e.g., carbon black), antioxidants, stabilizers, surfactants, waxes, flame retardants, anti-drip additives, nucleating agents (e.g., boron nitride) and other materials added to enhance properties and processability. Lubricants, for example, may be employed in the polymer composition that are capable of withstanding the processing conditions of the liquid crystalline polymer without substantial decomposition. Examples of such lubricants include fatty acids esters, the salts thereof, esters, fatty acid amides, organic phosphate esters, and hydrocarbon waxes of the type commonly used as lubricants in the processing of engineering plastic materials, including mixtures thereof. Suitable fatty acids typically have a backbone carbon chain of from about 12 to about 60 carbon atoms, such as myristic acid, palmitic acid, stearic acid, arachic acid, montanic acid, octadecinic acid, parinric acid, and so forth. Suitable esters include fatty acid esters, fatty alcohol esters, wax esters, glycerol esters, glycol esters and complex esters. Fatty acid amides include fatty primary amides, fatty secondary amides, methylene and ethylene bisamides and alkanolamides such as, for example, palmitic acid amide, stearic acid amide, oleic acid amide, N,N′-ethylenebisstearamide and so forth. Also suitable are the metal salts of fatty acids such as calcium stearate, zinc stearate, magnesium stearate, and so forth; hydrocarbon waxes, including paraffin waxes, polyolefin and oxidized polyolefin waxes, and microcrystalline waxes. Particularly suitable lubricants are acids, salts, or amides of stearic acid, such as pentaerythritol tetrastearate, calcium stearate, or N,N′-ethylenebisstearamide. When employed, the lubricant(s) typically constitute from about 0.05 wt. % to about 1.5 wt. %, and in some embodiments, from about 0.1 wt. % to about 0.5 wt. % (by weight) of the polymer composition.

### II. Formation

The components of the polymer composition may be melt processed or blended together. The components may be supplied separately or in combination to an extruder that includes at least one screw rotatably mounted and received within a barrel (e.g., cylindrical barrel) and may define a feed section and a melting section located downstream from the feed section along the length of the screw. The extruder may be a single screw or twin screw extruder. The speed of the screw may be selected to achieve the desired residence time, shear rate, melt processing temperature, etc. For example, the screw speed may range from about 50 to about 800 revolutions per minute (“rpm”), in some embodiments from about 70 to about 150 rpm, and in some embodiments, from about 80 to about 120 rpm. The apparent shear rate during melt blending may also range from about 100 seconds⁻¹ to about 10,000 seconds⁻¹, in some embodiments from about 500 seconds⁻¹ to about 5000 seconds⁻¹, and in some embodiments, from about 800 seconds⁻¹ to about 1200 seconds⁻¹. The apparent shear rate is equal to 4Q/πR³, where Q is the volumetric flow rate (“m³/s”) of the polymer melt and R is the radius (“m”) of the capillary (e.g., extruder die) through which the melted polymer flows.

### III. Camera Module

As indicated above, the polymer composition of the present invention is particularly well suited for use in a camera module. Typically, the camera module includes a housing which a lens module is positioned that contains one or more lenses. However, the particular configuration of the camera module may vary as is known to those skilled in the art.

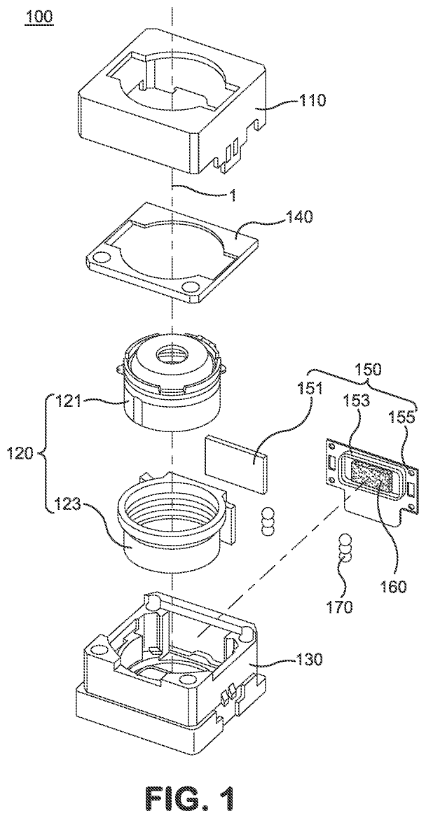

Referring to FIG. 1, for example, one embodiment of a camera module 100 is shown that contains a lens module 120 that is contained within a housing, wherein the lens module 120 contains a lens barrel 121 coupled to a lens holder 123. The lens barrel 121 may have a hollow generally cylindrical shape so that one or more lenses for imaging an object may be received therein in an optical axis direction 1. The lens barrel 121 may be inserted into a hollow cavity provided in the lens holder 123, which may also be generally cylindrical, and the lens barrel 121 and the lens holder 123 may be coupled to each other by a fastener (e.g., screw), adhesive, etc. The lens module 120, including the lens barrel 121, may be moveable in in the optical axis direction 1 (e.g., for auto-focusing) by an actuator assembly 150. In the illustrated embodiment, for example, the actuator assembly 150 may include a magnetic body 151 and a coil 153 configured to move the lens module 120 in the optical axis direction 1. The magnetic body 151 may be mounted on one side of the lens holder 123, and the coil 153 may be disposed to face the magnetic body 151. The coil 153 may be mounted on a substrate 155, which is in turn may be mounted to the housing 130 so that the coil 153 faces the magnetic body 151. The actuator assembly 150 may include a drive device 160 that is mounted on the substrate 155 and that outputs a signal (e.g., current) for driving the actuator assembly 150 depending on a control input signal. The actuator assembly 150 may receive the signal and generate a driving force that moves the lens module 120 in the optical axis direction 1. If desired, a stopper 140 may also be mounted on the housing 130 to limit a moving distance of the lens module 120 in the optical axis direction 1. Further, a shield case 110 (e.g., metal) may also be coupled to the housing 130 to enclose outer surfaces of the housing 130, and thus block electromagnetic waves generated during driving of the camera module 100.

The actuator assembly may also include a guide unit that is positioned between the housing and the lens module to help guide the movement of the lens module. Any of a variety of guide units may be employed as known in the art, such as spring(s), ball bearing(s), electrostatic force generators, hydraulic force generators, etc. For example, springs can be employed that generate a preload force that acts on the lens module and guides it into the desired optical axis direction. Alternatively, as illustrated in the embodiment shown in FIG. 1, ball bearings 170 may act as a guide unit of the actuator assembly 150. More specifically, the ball bearings 170 may contact an outer surface of the lens holder 123 and an inner surface of the housing 130 to guide the movement of the lens module 120 in the optical axis direction 1. That is, the ball bearings 170 may be disposed between the lens holder 123 and the housing 130, and may guide the movement of the lens module 120 in the optical axis direction through a rolling motion. Any number of ball bearings 170 may generally be employed for this purpose, such as 2 or more, in some embodiments from 3 to 20, and in some embodiments, from 4 to 12. The ball bearings 170 may be spaced apart or in contact with each other, and may also be stacked in a direction perpendicular to the optical axis direction 1. The size of the ball bearings 170 may vary as is known to those skilled in the art. For instance, the ball bearings may have an average size (e.g., diameter) of about 800 micrometers or less, in some embodiments about 600 micrometers or less, in some embodiments about 400 micrometers or less, and in some embodiments, from about 50 to about 200 micrometers.

Notably, the polymer composition of the present invention may be employed in any of a variety of parts of the camera module. Referring again to FIG. 1, for instance, the polymer composition may be used to form all or a portion of the guide unit (e.g., ball bearings 170), housing 130, lens barrel 121, lens holder 123, substrate 155, stopper 140, shield case 110, and/or any other portion of the camera module. For example, it may be particularly desirable to employ the composition in the lens barrel 121 and/or the lens holder 123 to help minimize optical misalignment.

It should of course be understood that any of a variety of different camera module configurations may employ the polymer composition of the present invention. In the embodiments referenced above, for example, the camera module is an optical imaging device configured to capture an image. If desired, however, the camera module may also be employed for other purposes, such as to detect a biometric parameter (e.g., temperature). In such embodiments, one or more lenses of the camera module may be coated with an infrared filter film as is known to those skilled in the art. The lenses may be provided in a lens barrel, which may be formed from the polymer composition of the present invention. Light may enter the lens barrel from a lighting port, where it is able to contact the infrared filter film arranged on a surface of one or more lenses. If desired, the lighting port may also be formed from the polymer composition of the present invention. Examples of such infrared camera modules may be described, for instance, in WO 2021/163850, which is incorporated herein by reference.

Regardless of the manner in which it is employed, the desired part(s) may be formed using a variety of different techniques. Suitable techniques may include, for instance, injection molding, low-pressure injection molding, extrusion compression molding, gas injection molding, foam injection molding, low-pressure gas injection molding, low-pressure foam injection molding, gas extrusion compression molding, foam extrusion compression molding, extrusion molding, foam extrusion molding, compression molding, foam compression molding, gas compression molding, etc. For example, an injection molding system may be employed that includes a mold within which the polymer composition may be injected. The time inside the injector may be controlled and optimized so that polymer matrix is not pre-solidified. When the cycle time is reached and the barrel is full for discharge, a piston may be used to inject the composition to the mold cavity. Compression molding systems may also be employed. As with injection molding, the shaping of the polymer composition into the desired article also occurs within a mold. The composition may be placed into the compression mold using any known technique, such as by being picked up by an automated robot arm. The temperature of the mold may be maintained at or above the solidification temperature of the polymer matrix for a desired time period to allow for solidification. The molded product may then be solidified by bringing it to a temperature below that of the melting temperature. The resulting product may be de-molded. The cycle time for each molding process may be adjusted to suit the polymer matrix, to achieve sufficient bonding, and to enhance overall process productivity.

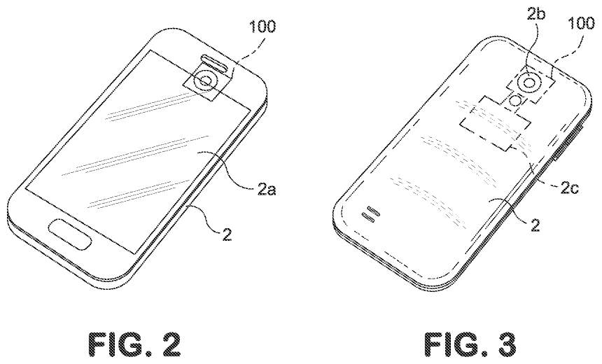

The resulting camera module may be used in a wide variety of electronic devices as is known in the art, such as in portable electronic devices (e.g., mobile phones, portable computers, tablets, watches, etc.), computers, televisions, automotive parts, etc. In one particular embodiment, the polymer composition may be employed in a camera module, such as those commonly employed in wireless communication devices (e.g., cellular telephone). Referring to FIGS. 2-3, for example, one embodiment of an electronic device 2 (e.g., phone) is shown that includes a camera module 100. As illustrated, a lens of the camera module 100 may be exposed to the outside of the electronic device 2 through an opening 2b to image an external object. The camera module 100 may also be electrically connected to an application integrated circuit 2c to perform a control operation depending on selection of a user.

### Test Methods

Melt Viscosity: The melt viscosity (Pa-s) may be determined in accordance with ISO Test No. 11443:2014 at a shear rate of 1,000 s⁻1 and temperature 15° C. above the melting temperature using a Dynisco LCR7001 capillary rheometer. The rheometer orifice (die) had a diameter of 1 mm, length of 20 mm, L/D ratio of 20.1, and an entrance angle of 180°. The diameter of the barrel was 9.55 mm+0.005 mm and the length of the rod was 233.4 mm.

Melting Temperature: The melting temperature (“Tm”) may be determined by differential scanning calorimetry (“DSC”) as is known in the art. The melting temperature is the differential scanning calorimetry (DSC) peak melt temperature as determined by ISO Test No. 11357-2:2020. Under the DSC procedure, samples were heated and cooled at 20° C. per minute as stated in ISO Standard 10350 using DSC measurements conducted on a TA Q2000 Instrument.

Deflection Temperature Under Load (“DTUL”): The deflection under load temperature may be determined in accordance with ISO Test No. 75-2:2013 (technically equivalent to ASTM D648-18). More particularly, a test strip sample having a length of 80 mm, thickness of 10 mm, and width of 4 mm may be subjected to an edgewise three-point bending test in which the specified load (maximum outer fibers stress) was 1.8 Megapascals. The specimen may be lowered into a silicone oil bath where the temperature is raised at 2° C. per minute until it deflects 0.25 mm (0.32 mm for ISO Test No. 75-2:2013).

Tensile Modulus, Tensile Stress, and Tensile Elongation: Tensile properties may be tested according to ISO Test No. 527:2019 (technically equivalent to ASTM D638-14). Modulus and strength measurements may be made on the same test strip sample having a length of 80 mm, thickness of 10 mm, and width of 4 mm. The testing temperature may be 23° C., and the testing speeds may be 1 or 5 mm/min.

Flexural Modulus, Flexural Stress, and Flexural Elongation: Flexural properties may be tested according to ISO Test No. 178:2019 (technically equivalent to ASTM D790-10). This test may be performed on a 64 mm support span. Tests may be run on the center portions of uncut ISO 3167 multi-purpose bars. The testing temperature may be 23° C. and the testing speed may be 2 mm/min.

Charpy Impact Strength: Charpy properties may be tested according to ISO Test No. ISO 179-1:2010) (technically equivalent to ASTM D256-10, Method B). This test may be run using a Type 1 specimen size (length of 80 mm, width of 10 mm, and thickness of 4 mm). When testing the notched impact strength, the notch may be a Type A notch (0.25 mm base radius). Specimens may be cut from the center of a multi-purpose bar using a single tooth milling machine. The testing temperature may be 23° C.

Mean Coefficient of Linear Thermal Expansion (“CLTE”): This property may be measured by thermomechanical analysis in accordance with ISO 11359-2:1999. During the analysis, a specimen is placed on the sample stage at room temperature. The specimen is a 5 mm×5 mm×4 mm part prepared from the middle of an ISO tensile bar (80 mm×10 mm×4 mm) as set forth in ISO 294-4:2018. Once placed on the sample stage, the height of the specimen is measured by the probe. The furnace is lowered and the temperature is brought to the lowest temperature of interest. The specimen is heated at a specified rate (e.g., 5° C. per minute) over the desired temperature range—i.e., from −45° C. to 200° C.—with a first heat to remove thermal memory, a cooling cycle, and a second heat for the analysis. A graph is produced in which the dimensional change (μm) is plotted as a function of temperature (° C.). The CLTE, α, is then determined according to the following equation:

α=ΔL/ΔT×1/L₀

wherein,

ΔT=200° C. (T₂)−−45° C. (T₁)=245° C.;

ΔL is the change in length of the test specimen between the two temperatures, T₂ and T₁; and

L₀ is the reference length of the test specimen at room temperature in the axis of measurement (e.g., flow or transverse direction).

Measurements are generally taken parallel to the flow direction and/or transverse to the flow direction.

### COMPARATIVE EXAMPLE 1

A comparative sample was formed that contained 67.2 wt. % LCP 1, 30 wt. % wollastonite fibers, 2.5 wt. % carbon black, and 0.3 wt. % of a lubricant. LCP 1 is formed from 60% HBA, 5% HNA, 17.5% TA, 12.5% BP, and 5% APAP.

### COMPARATIVE EXAMPLE 2

A comparative sample was formed that contained 57.2 wt. % LCP 1, 40 wt. % calcium pyrophosphate, 2.5 wt. % carbon black, and 0.3 wt. % of a lubricant.

### EXAMPLES 1-6

Samples 1-6 are formed for use in a camera module as described herein. The samples are formed from various combinations of a first liquid crystalline polymer (“LCP 2”), a second liquid crystalline polymer (“LCP 3”), talc particles, aluminum hydroxide (“ATH”), and a lubricant. LCP 2 is formed from 43% HBA, 20% NDA, 9% TA, and 28% HQ. LCP 3 is formed from 48% HNA, 2% HBA, 25% TA, and 25% BP. The talc particles have a D50 median diameter of 7.5 micrometers (Sedigraph 5120), BET specific surface area of 3.8 m²/g, and moisture content at 105° C. of no more than 0.4%. ATH is in the form of particles having a D50 median diameter of approximately 1 micrometer. Compounding is performed using a 32-mm twin screw extruder.

TABLE 1

| | 1 | 2 | 3 | 4 | 5 | 6 |
|---|---|---|---|---|---|---|
| Sample | (wt. %) | (wt. %) | (wt. %) | (wt. %) | (wt. %) | (wt. %) |
| LCP 1 | — | — | — | — | — | 5.6 |
| LCP 2 | 46 | 46 | 50.8 | — | — | 37.3 |
| LCP 3 | — | — | — | 39.7 | 39.5 | — |
| Black Pigment | — | — | — | — | — | 2.4 |
| Talc | 54 | 54 | 49 | 60 | 60 | 54 |
| ATH | 0.2 | 0.4 | 0.2 | 0.3 | 0.5 | 0.4 |
| Lubricant | — | — | — | — | — | 0.3 |

The resulting samples are injection molded into ISO tensile bars (80 mm×10 mm×4 mm) and tested for thermal and mechanical properties. The results are set forth below in Table 2.

TABLE 2

| | Comp. | Comp. | | | | | | |
|---|---|---|---|---|---|---|---|---|
| | Ex. 1 | Ex. 2 | 1 | 2 | 3 | 4 | 5 | 6 |
| CLTE (° C.⁻¹) | 15 | 28 | — | 11 | 10 | — | 11 | 11 |
| Flow Direction for - | | | | | | | | |
| 45° C. to 200° C. | | | | | | | | |
| CLTE (° C.⁻¹) | 86 | 64 | — | 23 | 33 | — | 17 | 17 |
| Transverse Direction | | | | | | | | |
| for −45° C. to 200° C. | | | | | | | | |
| In-Plane Thermal | 2.5 | 1.2 | 4.2 | 4.8 | 4.1 | 5.1 | 5.1 | 4.8 |
| Conductivity (W/m-K) | | | | | | | | |
| Through-Plane Thermal | 0.6 | 0.35 | 0.7 | 0.8 | 0.7 | 1.0 | 1.0 | 0.9 |
| Conductivity (W/m-K) | | | | | | | | |
| Melting Temperature | 330 | 330 | 319 | 318 | 319 | 343 | 338 | 319 |
| (° C., 1^{st} heat of DSC) | | | | | | | | |
| Melt Viscosity at | — | 52 | 52 | 30 | 38 | 37 | 29 | 42 |
| 1,000 s⁻¹ (Pa-s) | | | | | | | | |
| Unnotched Charpy | 29.0 | — | 20.0 | 13.0 | 9.3 | 4.5 | 3.5 | 9 |
| (kJ/m²) | | | | | | | | |
| Notched Charpy | 10.0 | 4.0 | 2.5 | 2.5 | 1.8 | 1.3 | 1.2 | 2.1 |
| (kJ/m²) | | | | | | | | |
| Tensile Strength (MPa) | 143 | 103 | 74 | 82 | 83 | 65 | 50 | 62 |
| Tensile Modulus (MPa) | 14,000 | 9,111 | 9,710 | 9,427 | 9,535 | 11,195 | 11,546 | 10,341 |
| Tensile Elongation (%) | 2.7 | 3.8 | 1.6 | 2.1 | 2.4 | 0.8 | 0.7 | 0.9 |
| Flexural Strength | 160 | 125 | 97 | 109 | 113 | 101 | 94 | 94 |
| (MPa) | | | | | | | | |
| Flexural Modulus | 13,000 | 9,135 | 9,618 | 9,410 | 9,766 | 13,093 | 13,958 | 11,283 |
| (MPa) | | | | | | | | |
| Flexural Elongation (%) | — | >3.5 | 1.8 | 2.3 | 2.8 | 1.2 | 1.0 | 1.3 |
| DTUL (1.8 MPa, ° C.) | 240 | 218 | 256 | 261 | 260 | 279 | 273 | 243 |

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed is:

1. A camera module comprising a polymer composition that includes a polymer matrix containing a liquid crystalline polymer and a plurality of inorganic filler particles, wherein the polymer composition exhibits an in-plane thermal conductivity of about 2.5 W/m-K or more as determined in accordance with ASTM E1461-13 and a mean coefficient of linear thermal expansion of about 50° C.⁻1 or less as determined in a direction transverse to a flow direction in accordance with ISO 11359-2:1999 over a temperature range of from −45° C. to 200° C.

2. The camera module of claim 1, wherein the polymer composition exhibits a mean coefficient of linear thermal expansion of about 25° C.⁻1 or less as determined in a direction parallel to a flow direction in accordance with ISO 11359-2:1999 over a temperature range of from −45° C. to 200° C.

3. The camera module of claim 1, wherein the polymer composition exhibits a melt viscosity of from about 1 to about 100 Pa-s as determined in accordance with ISO Test No. 11443:2014 at a temperature 15° C. higher than the melting temperature of the polymer composition.

4. The camera module of claim 1, wherein the polymer composition exhibits a through-plane thermal conductivity of about 0.6 W/m-K or more as determined in accordance with ASTM E 1461-13.

5. The camera module of claim 1, wherein the polymer composition exhibits an in-plane thermal conductivity of from about 4 to about 10 W/m-K and a through-plane thermal conductivity of from about 0.8 to about 2 W/m-K, as determined in accordance with ASTM E 1461-13.

6. The camera module of claim 1, wherein the polymer composition exhibits a mean coefficient of linear thermal expansion of from about 1 to about 35° C.⁻1 as determined in a direction transverse to a flow direction in accordance with ISO 11359-2:1999 over a temperature range of from −45° C. to 200° C. and a mean coefficient of linear thermal expansion of from about 1 to about 13° C.⁻1 as determined in a direction parallel to a flow direction in accordance with ISO 11359-2:1999 over a temperature range of from −45° C. to 200° C.

7. The camera module of claim 1, wherein the polymer composition exhibits a melt viscosity of from about 5 to about 60 Pa-s as determined in accordance with ISO Test No. 11443:2014 at a temperature 15° C. higher than the melting temperature.

8. The camera module of claim 1, wherein the polymer matrix constitutes from about 20 wt. % to about 65 wt. % of the polymer composition.

9. The camera module of claim 1, wherein the liquid crystalline polymer has a melting temperature of about 280° C. to about 400° C.

10. The camera module of claim 1, wherein the liquid crystalline polymer contains repeating units derived from one or more aromatic dicarboxylic acids, one or more aromatic hydroxycarboxylic acids, or a combination thereof.

11. The camera module of claim 10, wherein the aromatic hydroxycarboxylic acids include 4-hydroxybenzoic acid, 6-hydroxy-2-naphthoic acid, or a combination thereof.

12. The camera module of claim 10, wherein the aromatic dicarboxylic acids include terephthalic acid, isophthalic acid, 2,6-naphthalenedicarboxylic acid, or a combination thereof.

13. The camera module of claim 10, wherein the liquid crystalline polymer further contains repeating units derived from one or more aromatic diols.

14. The camera module of claim 13, wherein the aromatic diols include hydroquinone, 4,4′-biphenol, or a combination thereof.

15. The camera module of claim 1, wherein the liquid crystalline polymer is wholly aromatic.

16. The camera module of claim 1, wherein the liquid crystalline polymer contains repeating units derived from naphthenic hydroxycarboxylic and/or dicarboxylic acids in an amount of about 10 mol. % or more.

17. The camera module of claim 16, wherein the liquid crystalline polymer contains repeating units derived from 6-hydroxy-2-naphthoic acid in an amount of about 30 mol. % or more.

18. The camera module of claim 16, wherein the liquid crystalline polymer contains repeating units derived from 2,6-naphthalenedicarboxylic acid in an amount of about 10 mol. % or more.

19. The camera module of claim 16, wherein liquid crystalline polymers containing repeating units derived from hydroxycarboxylic and/or dicarboxylic acids in an amount of about 10 mol. % or more constitute about 60 wt. % or more of the polymer matrix.

20. The camera module of claim 1, wherein the inorganic filler particles are present in an amount of from about 60 to about 300 parts by weight per 100 parts by weight of the polymer matrix.

21. The camera module of claim 1, wherein the inorganic filler particles constitute from about 40 wt. % to about 60 wt. % of the polymer composition.

22. The camera module of claim 1, wherein the inorganic filler particles include talc.

23. The camera module of claim 1, wherein the inorganic filler particles have a median diameter of from about 1 to about 25 micrometers, specific surface area of from about 1 to about 50 m²/g as determined in accordance with DIN 66131:1993, and/or moisture content of about 5% or less as determined in accordance with ISO 787-2:1981 at a temperature of 105° C.

24. The camera module of claim 1, wherein the polymer composition further comprises a metal hydroxide, wherein the metal hydroxide has the general formula M(OH)ₐO_{b}, where M is a metal, 0≤a≤3, and b=(3−a)/2.

25. The camera module of claim 24, wherein the metal hydroxide includes aluminum hydroxide.

26. The camera module of claim 24, wherein the metal hydroxide constitutes from about 0.01 wt. % to about 5 wt. % of the polymer composition.

27. The camera module of claim 24, wherein the metal hydroxide is present in an amount of from about 0.1 to about 20 parts by weight per 100 parts by weight of the polymer matrix.

28. The camera module of claim 1, wherein the polymer composition is free of fillers having an intrinsic thermal conductivity of 100 W/m-K or more.

29. The camera module of claim 1, wherein the camera module comprises a housing within which a lens module is positioned that contains one or more lenses.

30. The camera module of claim 29, wherein at least a portion of the housing, lens module, or a combination thereof contains the polymer composition.

31. The camera module of claim 29, wherein the lens module contains a lens barrel coupled to a lens holder.

32. The camera module of claim 31, wherein at least a portion of the lens holder, the lens barrel, or a combination thereof, contains the polymer composition.

33. The camera module of claim 32, wherein the lens barrel receives the one or more lenses.

34. The camera module of claim 32, wherein the lens barrel and the lens holder are generally cylindrical.

35. The camera module of claim 29, wherein one or more of the lenses are coated with an infrared filter.

36. An electronic device comprising the camera module of claim 1.

37. The electronic device of claim 36, wherein the device is a wireless communication device.
